(19) United States
(12) Patent Application Publication
(10) Pub. No.: US 2016/0357203 A1
(43) Pub. Date: Dec. 8, 2016

(54) INTELLIGENT FEEDBACK MECHANISM FOR A POWER CONTROL CIRCUIT

(71) Applicants: Colm Slattery, Clonmel (IE); Aidan J. Cahalane, Co Clare (IE); Alan Patrick Cahill, Edinburgh (GB)

(72) Inventors: Colm Slattery, Clonmel (IE); Aidan J. Cahalane, Co Clare (IE); Alan Patrick Cahill, Edinburgh (GB)

(21) Appl. No.: 15/174,553

(22) Filed: Jun. 6, 2016

Related U.S. Application Data
(60) Provisional application No. 62/171,764, filed on Jun. 5, 2015.

(51) Int. Cl. G05F 1/46

(52) U.S. Cl. CPC G05F 1/46

(57) ABSTRACT

Embodiments of the present invention may provide an integrated circuit with reduced power loss. The integrated circuit may comprise a processing system and a feedback circuit. The processing system may generate a load signal from a variable power supply, which is external to the integrated circuit. The feedback circuit may compare the load signal and a voltage input from the variable power supply, and based on the comparison, generate a feedback signal for adjusting the variable power supply, thereby reducing power loss.

### CLAIM OF PRIORITY AND RELATED APPLICATIONS

This patent application claims the benefit of priority of Slattery, U.S. Provisional Patent Application Ser. No. 62/171,764, entitled “INTELLIGENT FEEDBACK MECHANISM FOR A POWER CONTROL CIRCUIT,” filed on Jun. 5, 2015 (Attorney Docket No. 3867.249PRV), which is hereby incorporated by reference herein in its entirety.

### TECHNICAL FIELD

The present subject matter relates generally to, but not by way of limitation, power control circuits.

### BACKGROUND

Many applications e.g., factory automation, process automation) include remotely-located load circuits that require low load voltages or currents. A power control circuit can provide these low voltages and currents. Generally, a power control circuit will convert supply voltages from a power supply to the desired low voltage or current based on the load circuit's needs, which can fluctuate over time. The supply voltages, however, are typically static voltages generated by the power supply. These fixed supply voltages are usually high voltages to ensure the full range of possible load voltages or currents can be provided. Thus, there can be significant power loss in these types of systems when the supply voltages and load voltages/currents differ substantially.

One solution to overcome this power loss is to introduce an on-chip direct current-to-direct current (DC-DC) controller in the power control circuit. The on-chip DC-DC controller can sense the load voltage (or current) and generate a driver voltage that tracks the load voltage (or current). While this technique can reduce the on-chip power dissipation under the worst conditions, there is still some power loss in the conversion by the on-chip DC-DC controller. Typically, the on-chip DC-DC controllers operate at ˜80% efficiency. Further, the power supply signals used in this technique are still static signals, which can be another source of power loss (˜85 efficient). Thus, the total system efficiency can be reduced to <70%, taking into account the inefficiencies of both the on-chip DC-DC controller and the power source.

Therefore, there is a need in the art for a power control circuit that overcomes the above-mentioned drawbacks.

### BRIEF DESCRIPTION OF THE DRAWINGS

FIG. 1 illustrates a power distribution system according to an embodiment of the present invention.

FIG. 2 illustrates exemplary waveforms according to an embodiment of the present invention.

FIG. 3 illustrates a power distribution system according to an embodiment of the present invention.

FIG. 4 illustrates a power distribution system according to an embodiment of the present invention.

FIG. 5 illustrates a power distribution system according to one embodiment of the present invention.

FIG. 6 illustrates a power distribution system according to an embodiment of the present invention.

### DETAILED DESCRIPTION

Embodiments of the present invention may provide an integrated circuit with reduced power loss. The integrated circuit may comprise a processing system and a feedback circuit. The processing system may generate a load signal from a variable power supply, which is external to the integrated circuit. The feedback circuit may compare the load signal and a voltage input from the variable power supply, and based on the comparison, generate a feedback signal for adjusting the variable power supply, thereby reducing power loss.

Embodiments of the present invention may provide a method for reducing power loss in a power supply system. The method may comprise the steps of receiving a variable power supply from an external source; converting the variable power supply to a load signal, which is lower in magnitude than the power supply; sensing a value of the load signal; comparing the value of the load signal and a value of the power supply; generating, based on the comparison, a feedback signal to modify the variable power supply; and transmitting the feedback signal to the external source.

Embodiments of the present invention may provide a system with reduced power loss. The system may comprise a power management unit, a load unit, and a power supply unit. The power management unit may generate an input power signal. The load unit may receive a load supply signal that is different from the input power signal. The power supply unit may be coupled to the power management unit and the load unit. The power supply may comprise an input to receive the input power signal, circuitry to generate the load supply signal from the input power signal, and a feedback circuit to generate a feedback signal based on variation in a difference between the load supply signal and the input power signal, wherein the power management unit receives the feedback signal and adjusts the input power signal based on the feedback signal.

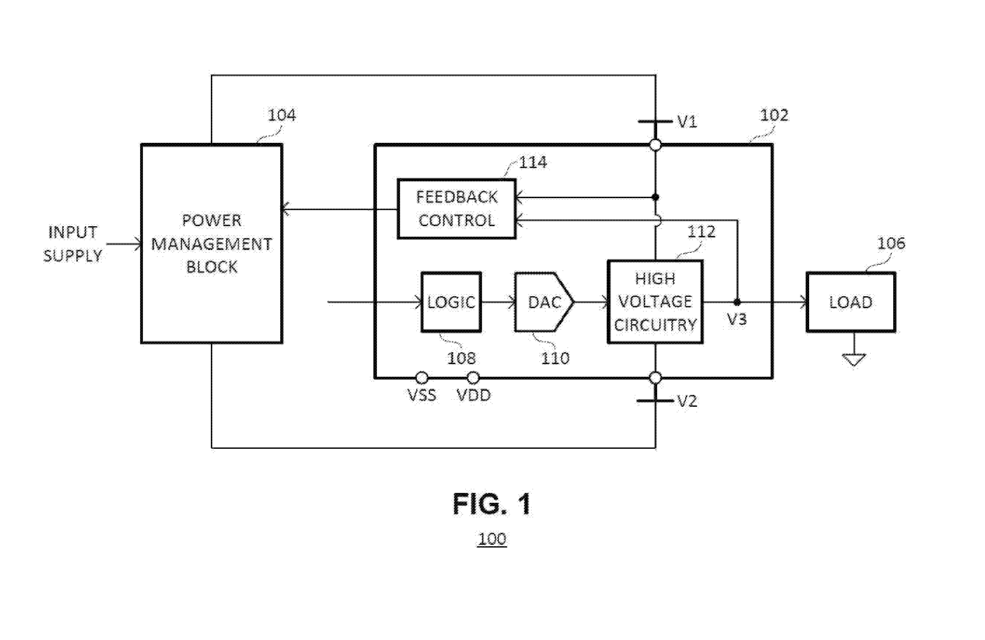

FIG. 1 illustrates a power distribution system 100 according to an embodiment of the present invention. The power distribution system 100 may include a power control circuit 102, a power management block 104, and a load unit 106.

The power management block 104 may receive an input supply and may generate voltages V1 and V2. The voltages V1 and V2 may be rail voltages, where V1 may represent a positive-rail voltage and V2 may represent a negative-rail voltage. The power management block 104, in an embodiment, may include a DC-DC controller to generate the voltages V1 and V2 based on the input supply, which may be a high voltage. Various embodiments of the power management block are described in further detail below. The power management block 104 may be coupled to the power control circuit 102.

The power control circuit 102 may be provided as an integrated circuit (IC) chip, which does not include the power management block 104 and load unit 106. The power control circuit 102 may have a pair of inputs VDD and VSS (Ground) to supply an operating power to the components in the power control circuit 102. The power control circuit 102 may include a logic circuit 108, a digital-to-analog converter (DAC) 110, high voltage circuitry 112, and a feedback control unit 114.

As mentioned, the power management block 104 may be coupled to the power control circuit 102, and the power management block 104 may provide the voltages V1 and V2 to the power control circuit 102. Thus, in addition to the pair of inputs VDD and VSS, the power control circuit 102 may be exposed to a power supply, which defines an effective voltage between them as V1-V2. In turn, the power control circuit 102 may be coupled to the load unit 106, which may be located remotely to the power management block 104. The power control circuit 102 may provide a load signal to the load unit 106. The load signal may be a voltage, shown as V3 in the embodiment of FIG. 1, or a current depending on the requirements of the load unit 106.

The logic circuit 108 in the power control circuit 102 may receive a control input from a host device (not shown), for example a processor, indicating the power requirements of the load unit 106. For example, the control input may indicate that a 5-V voltage signal or 20-mA current or the like needs to be supplied to the load. The DAC 110 may convert the control input to an analog control signal.

The high voltage circuitry 112 may receive the analog control signal and the power supply V1-V2 as inputs, and may convert the power supply V1-V2 to the load signal V3 based on the analog control signal. For example, the high voltage circuitry 112 may include circuitry, such as a voltage amplifier, to scale and/or buffer the analog control signal to generate a load signal V3, which is supplied by the power supply V1-V2. The load signal V3 may be lower in magnitude than the magnitude of power supply V1-V2. The load signal V3 may fluctuate over time.

In this embodiment of FIG. 1, the load signal is shown as, but is not limited to, voltage V3; the load signal may also be a current. For example, the high voltage circuitry 112 may also include a voltage-to-current circuitry, driven by the analog control signal and powered by the power supply V1-V2, to generate a current to be provided to load unit 106.

The feedback control unit 114 may be coupled to the output of the high voltage circuitry 112 and may sense the load signal V3. For example, the feedback control unit 114 may sense the magnitude of the load signal V3. Alternatively, in applications where there may be any variation in the remote ground where the load is located, the feedback control unit 114 may sense the difference between the load signal V3 and the remote ground. The feedback control unit 114 may also sense the power supply V1-V2. For example, the feedback control unit 114 may sense the magnitude of the power supply signal V1-V2. The feedback control unit 114 may compare the magnitudes of the power supply signal V1-V2 and the load signal V3. Based on the comparison, the feedback control unit 114 may generate a feedback signal to transmit to the power management block 104. The feedback signal may provide instructions for the power management block 104 to dynamically adjust at least one of the voltages V1 and V2 to track the fluctuations in the load signal V3.

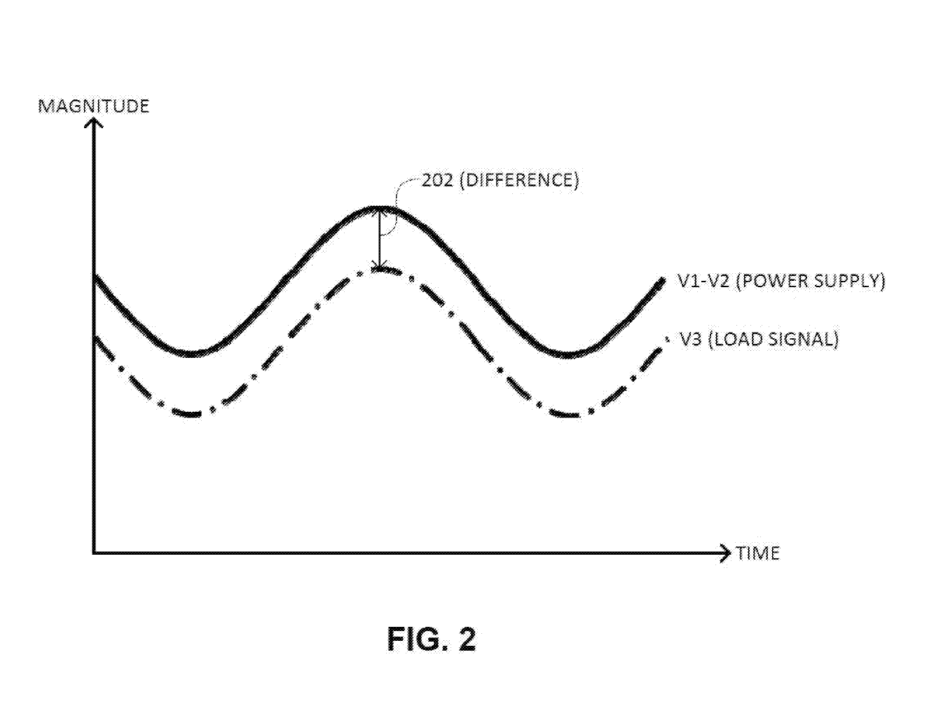

FIG. 2 illustrates exemplary waveforms according to an embodiment of the present invention. FIG. 2 illustrates the magnitudes of power supply V1-V2 and the load signal V3 over time. As shown, the load signal V3 may fluctuate over time. However, with the use of the feedback signal, the power supply V1-V2 may be dynamically adjusted to track the fluctuations of the load signal V3.

Thus, a difference 202 between the two signals my be controlled to be substantially constant, and the magnitude of the power supply V1-V2 may be controlled to be at a minimum value above the load signal V3. This may lead to significant power reduction in the system. Using the direct feedback technique described herein may save on cost and complexity because on-chip DC-DC controllers in the power control IC chip, as described in the background section, may be eliminated. Removing the DC-DC controllers from the IC chip may also eliminate external components needed to support them.

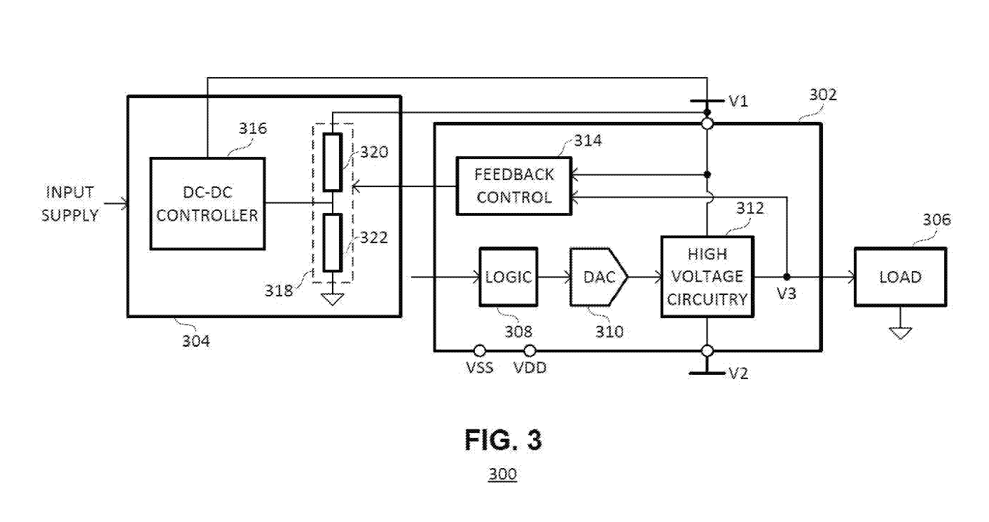

FIG. 3 illustrates a power distribution system 300 according to an embodiment of the present invention. The power distribution system 300 may include a power control circuit 302, a power management block 304, and a load unit 306.

The power management block 304 may receive an input supply and may generate voltages V1 and V2. The voltages V1 and V2 may be rail voltages, where V1 may represent a positive-rail voltage and V2 may represent a negative-rail voltage.

The power management block 304 may include a DC-DC controller 316, which may generate the voltages V1 and V2, and a voltage divider network 318, which may include a plurality of impedance elements. Two impedance elements 320 and 322 are shown in FIG. 3 for illustration purposes only, and more than two impedance elements may be provided in the voltage divider network 318. In an embodiment, the impedance elements may be resistors (i.e., resistor divider). The voltage divider network 318 may be coupled to a feedback node of the DC-DC controller 316.

The power control circuit 302 may be provided as an integrated circuit (IC) chip, which does not include the power management block 304 and load unit 306. The power control circuit 302 may have a pair of inputs VDD and VSS (Ground) to supply an operating power to the components in the power control circuit 302. The power control circuit 302 may include a logic circuit 308, a digital-to-analog converter (DAC) 310, high voltage circuitry 312, and a feedback control unit 314.

The power management block 304 may be coupled to the power control circuit 302, and the power management block 304 may provide the voltages V1 and V2 to the power control circuit 302 Thus, in addition to the pair of inputs VDD and VSS, the power control circuit 302 may be exposed to a power supply, which defines an effective voltage between them as V1-V2. In turn, the power control circuit 302 may be coupled to the load unit 306, which may be located remotely to the power management block 304. The power control circuit 302 may provide a load signal to the load unit 306. The load signal may be a voltage, shown as V3 in the embodiment of FIG. 3, or a current depending on the requirements of the load unit 306.

The logic circuit 308 the power control circuit 302 may receive a control input from a host device (not shown), for example a processor, indicating the power requirements of the load unit 306. For example, the control input may indicate that a 5-V voltage signal or 20-mA current or the like needs to be supplied to the load. The DAC 310 may convert the control input to an analog control signal, which may then be used to control the high voltage circuitry 312. The high voltage circuitry 312 may receive the power supply V1-V2 as input, and may convert the power supply V1-V2 to the load signal V3 based on the analog control signal. For example, the high voltage circuitry 312 may include circuitry, such as a voltage amplifier, to scale and/or buffer the analog control signal to generate a load signal V3, which is supplied by the power supply V1-V2. The load signal V3 may be lower in magnitude than the magnitude of power supply V1-V2. The load signal V3 may fluctuate over time. In this embodiment of FIG. 3, the load signal is shown as, but is not limited to, voltage V3; the load signal may also be a current. For example, the high voltage circuitry 312 may also include a voltage-to-current circuitry, driven by the analog control signal and powered by the power supply V1-V2, to generate a current to be provided to load unit 306.

The feedback control unit 314 may be coupled to the output of the high voltage circuitry 312 and may sense the load signal V3. For example, the feedback control unit 314 may sense the magnitude of the load signal V3. The feedback control unit 314 may also sense the power supply V1-V2. For example, the feedback control unit 314 may sense the magnitude of the power supply V1-V2. The feedback control unit 314 may compare the magnitudes of the power supply V1-V2 and the load signal V3. Based on the comparison, the feedback control unit 314 may generate a feedback signal to transmit to the power management block 304. The feedback signal may provide instructions for the power management block 304 to dynamically adjust at least one of the voltages V1 and V2 to track the fluctuations in the load signal V3.

For example, the feedback signal sent by the feedback control unit 314 may adjust the impedance of at least one of the impedance elements 320 and 322 of the voltage divider network 318, effectively changing the signal sent to the feedback node of the DC-DC controller 316. The feedback node of the DC-DC controller 316 may act as a voltage control input. Therefore, the DC-DC controller 316 may dynamically adjust at least one of the voltages V1 and V2 to track the load signal V3 based on the feedback signal.

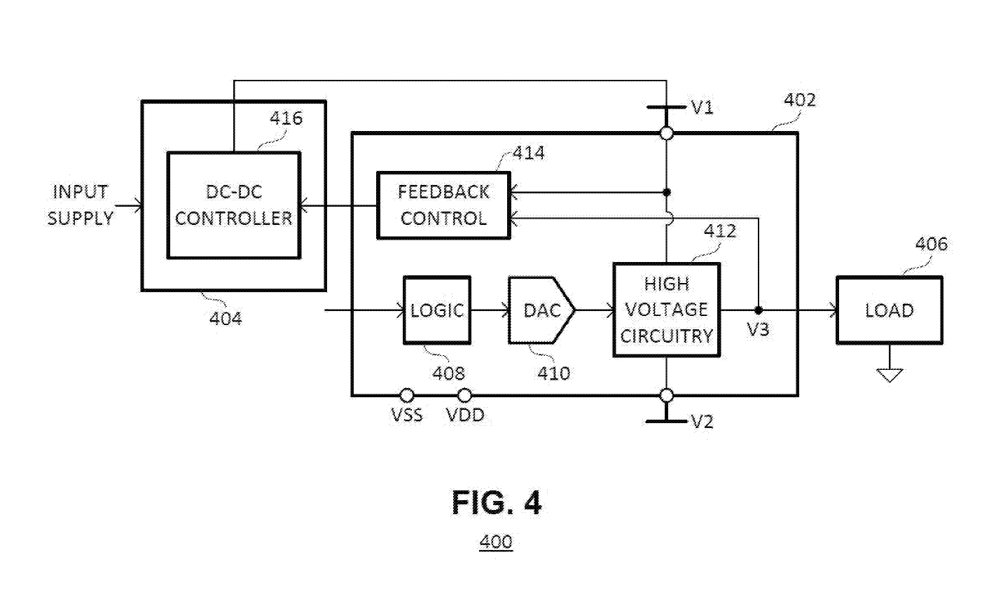

FIG. 4 illustrates a power distribution system 400 according to an embodiment of the present invention. The power distribution system 400 may include a power control circuit 402, a power management block 404, and a load unit 406.

The power management block 404 may receive an input supply and may generate voltages V1 and V2. The voltages V1 and V2 may be rail voltages, where V1 may represent a positive-rail voltage and V2 may represent a negative-rail voltage. The power management block 404 may include a DC-DC controller 416, which may generate the voltages V1 and V2.

The power control circuit 402 may be provided as an integrated circuit (IC) chip, which does not include the power management block 404 and load unit 406. The power control circuit 402 may have a pair of inputs VDD and VSS (Ground) to supply an operating power to the components in the power control circuit 402. The power control circuit 402 may include a logic circuit 408, a digital-to-analog converter (DAC) 410, high voltage circuitry 412, and a feedback control unit 414.

The power management block 404 may be coupled to the power control circuit 402, and the power management block 404 may provide the voltages V1 and V2 to the power control circuit 402. Thus, in addition to the pair of inputs VDD and VSS, the power control circuit 402 may be exposed to a power supply, which defines an effective voltage between them as V1-V2. In turn, the power control circuit 402 may be coupled to the load unit 406, which may be located remotely to the power management block 404. The power control circuit 402 may provide a load signal to the load unit 406. The load signal may be a voltage, shown as V3 in the embodiment of FIG. 4, or a current depending on the requirements of the load unit 406.

The logic circuit 408 in the power control circuit 402 may receive a control input from a host device (not shown), for example a processor, indicating the power requirements of the load unit 406. For example, the control input may indicate that a 5-V voltage signal or 20-mA current or the like needs to be supplied to the load. The DAC 410 may convert the control input to an analog control signal, which may then be used to control the high voltage circuitry 412. The high voltage circuitry 412 may receive the power supply V1-V2 as input, and may convert the power supply V1-V2 to the load signal V3 based on the analog control signal. For example, the high voltage circuitry 412 may include circuitry, such as a voltage amplifier, to scale and/or buffer the analog control signal to generate a load signal V3, which is supplied by the power supply V1-V2. The load signal V3 may be lower in magnitude than the magnitude of power supply V1-V2. The load signal V3 may fluctuate over time. In this embodiment of FIG. 1, the load signal is shown as, but is not limited to, voltage V3; the load signal may also be a current. For example, the high voltage circuitry 412 may also include a voltage-to-current circuitry, driven by the analog control signal and powered by the power supply V1-V2, to generate a current to be provided to load unit 406.

The feedback control unit 414 may be coupled to the output of the high voltage circuitry 412 and may sense the load signal V3. For example, the feedback control unit 414 may sense the magnitude of the load signal V3. Alternatively, in applications where there may be any variation in the remote ground where the load is located, the feedback control unit 114 may sense the difference between the load signal V3 and the remote ground. The feedback control unit 414 may also sense the power supply V1-V2. For example, the feedback control unit 414 may sense the magnitude of the power supply V1-V2. The feedback control unit 414 may compare the magnitudes of the power supply V1-V2 and the load signal V3. Based on the comparison, the feedback control unit 414 may generate a feedback signal to transmit to the power management block 404. The feedback signal may provide instructions for the power management block 404 to dynamically adjust at least one of the voltages V1 and V2 to track the fluctuations in the load signal V3.

For example, the feedback control unit 414 may send the feedback signal to the feedback node of the DC-DC controller 416. The feedback node of the DC-DC controller 416 may act as a voltage control input. Therefore, the DC-DC controller 416 may dynamically adjust at least one of the voltages V1 and V2 to track the load signal V3 based on the feedback signal.

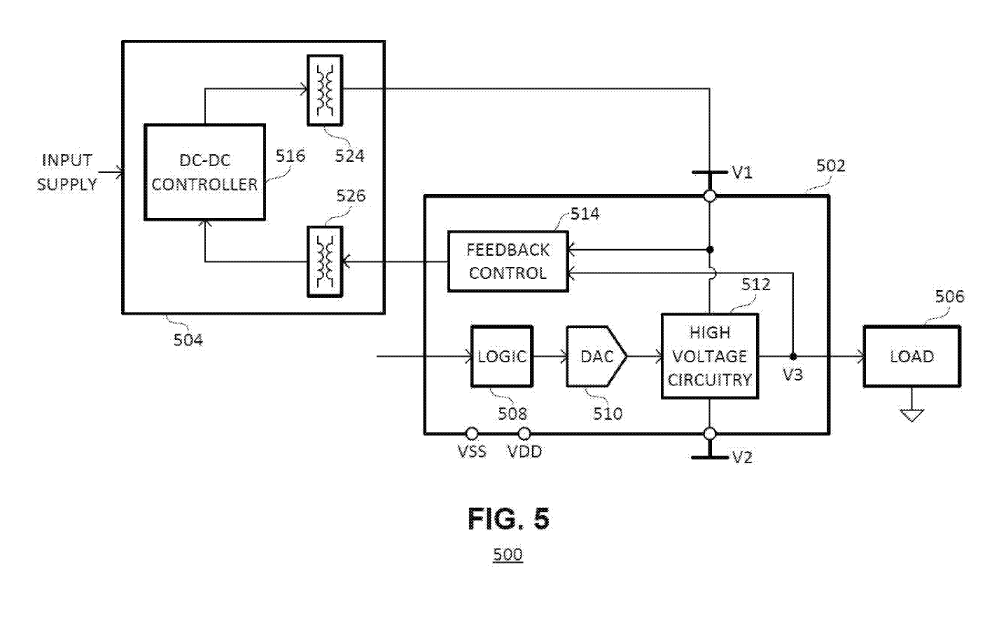

FIG. 5 illustrates a power distribution system 500 according to an embodiment of the present invention. The power distribution system 500 may include a power control circuit 502, a power management block 504, and a load unit 506.

The power management block 504 may receive an input supply and may generate voltages V1 and V2. The voltages V1 and V2 may be rail voltages, where V1 may represent a positive-rail voltage and V2 may represent a negative-rail voltage.

The power management block 504 may include a DC-DC controller 516 and a plurality of isolation blocks. Two isolation blocks 524 and 526 are shown in FIG. 5 for illustration purposes only, and more than two isolation blocks may be provided in the power management block 504. The isolation blocks 524 and 526 may provide isolation between the power management block 504 and the power control circuit 502.

The power control circuit 502 may be provided as an integrated circuit (IC) chip, which does not include the power management block 504 and load unit 506. The power control circuit 502 may have a pair of inputs VDD and VSS (Ground) to supply an operating power to the components in the power control circuit 502. The power control circuit 502 may include a logic circuit 508, a digital-to-analog converter (DAC) 510, high voltage circuitry 512, and a feedback control unit 514.

The power management block 504 may be coupled to the power control circuit 502, and the power management block 504 may provide to the power control circuit 502 the voltage V1 via isolation block 524 and the voltage V2 via another isolation block (not shown). Thus, in addition to the pair of inputs VDD and VSS, the power control circuit 502 may be exposed to a power supply, which defines an effective voltage between them as V1-V2. In turn, the power control circuit 502 may be coupled to the load unit 506, which may be located remotely to the power management block 504. The power control circuit 502 may provide a load signal to the load unit 506. The load signal may be a voltage, shown as V3 in the embodiment of FIG. 5, or a current depending on the requirements of the load unit 506.

The logic circuit 508 in the power control circuit 502 may receive a control input from a host device (not shown), for example a processor, indicating the power requirements of the load unit 506. For example, the control input may indicate that a 5-V voltage signal or 20-mA current or the like needs to be supplied to the load. The DAC 510 may convert the control input to an analog control signal, which may then be used to control the high voltage circuitry 512. The high voltage circuitry 512 may receive the power supply V1-V2 as input, and may convert the power supply V1-V2 to the load signal V3 based on the analog control signal. For example, the high voltage circuitry 512 may include circuitry, such as a voltage amplifier, to scale and/or buffer the analog control signal to generate a load signal V3, which is supplied by the power supply V1-V2. The load signal V3 may be lower in magnitude than the magnitude of power supply V1-V2. The load signal V3 may fluctuate over time. In this embodiment of FIG. 5, the load signal is shown as, but is not limited to, voltage V3; the load signal may also be a current. For example, the high voltage circuitry 512 may also include a voltage-to-current circuitry, driven by the analog control signal and powered by the power supply V1-V2, to generate a current to be provided to load unit 506.

The feedback control unit 514 may be coupled to the output of the high voltage circuitry 512 and may sense the load signal V3. For example, the feedback control unit 514 may sense the magnitude of the load signal V3. Alternatively, in applications where there may be any variation in the remote ground where the load is located, the feedback control unit 114 may sense the difference between the load signal V3 and the remote ground. The feedback control unit 514 may also sense the power supply V1-V2. For example, the feedback control unit 514 may sense the magnitude of the power supply V1-V2. The feedback control unit 514 may compare the magnitudes of the power supply V1-V2 and the load signal V3. Based on the comparison, the feedback control unit 514 may generate a feedback signal to transmit to the power management block 504. The feedback signal may provide instructions for the power management block 504 to dynamically adjust at least one of the voltages V1 and V2 to track the fluctuations in the load signal V3.

For example, the feedback control unit 514 may send the feedback signal to the feedback node of the DC-DC controller 516 via the isolation block 526. Although not shown in FIG. 5, the feedback signal, which is a digital signal, may be converted to an analog signal before being sent across the isolation barrier. It may also be possible to send the feedback signal as a digital signal across the isolation barrier. The feedback node of the DC-DC controller 516 may act as a voltage control input. Therefore, the DC-DC controller 516 may dynamically adjust at least one of the voltages V1 and V2 to track the load signal V3 based on the feedback signal.

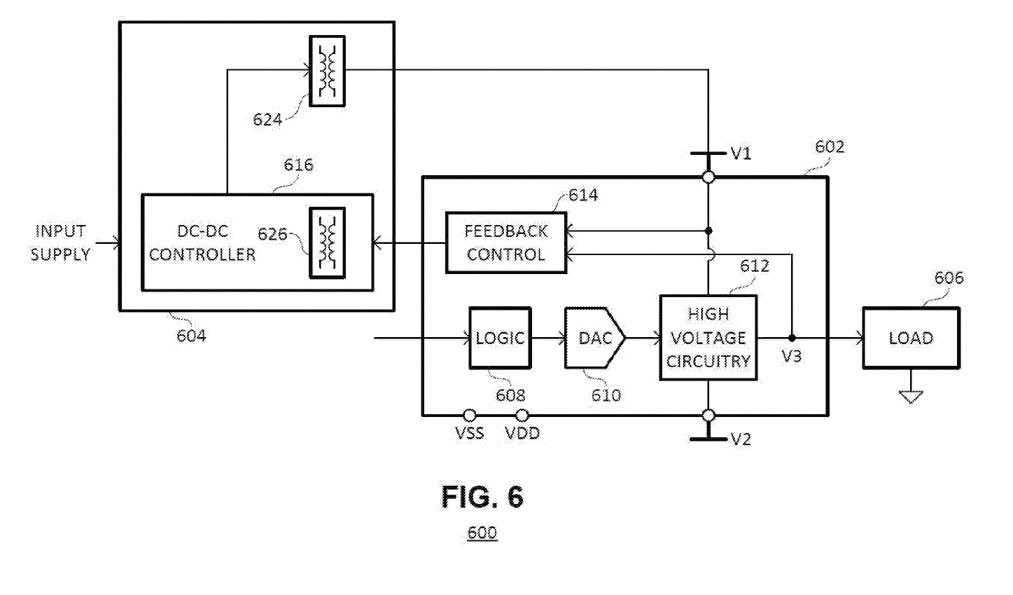

FIG. 6 illustrates a power distribution system 600 according to an embodiment of the present invention. The power distribution system 600 may include a power control circuit 602, a power management block 604, and a load unit 606.

The power management block 604 may receive an input supply and may generate voltages V1 and V2. The voltages V1 and V2 may be rail voltages, where V1 may represent a positive-rail voltage and V2 may represent a negative-rail voltage.

The power management block 604 may include a DC-DC controller 616 and a plurality of isolation blocks. Two isolation blocks 624 and 626 are shown in FIG. 6 for illustration purposes only, and more than two isolation blocks may be provided in the power management block 604. The isolation block 626 may reside within the DC-DC controller 616. The isolation blocks 624 and 626 may provide isolation between the power management block 504 and the power control circuit 502.

The power control circuit 602 may be provided as an integrated circuit (IC) chip, which does not include the power management block 604 and load unit 606. The power control circuit 602 may have a pair of inputs VDD and VSS (Ground) to supply an operating power to the components in the power control circuit 602. The power control circuit 602 may include a logic circuit 608, a digital-to-analog converter (DAC) 610, high voltage circuitry 612, and a feedback control unit 614.

The power management block 604 may be coupled to the power control circuit 602, and the power management block 604 may provide to the power control circuit 502 the voltage V1 via isolation block 624 and the voltage V2 via another isolation block (not shown). Thus, in addition to the pair of inputs VDD and VSS, the power control circuit 102 may be exposed to a power supply, which defines an effective voltage between them as V1-V2. In turn, the power control circuit 602 may be coupled to the load unit 606, which may be located remotely to the power management block 604. The power control circuit 602 may provide a load signal to the load unit 606. The load signal may be a voltage, shown as V3 in the embodiment of FIG. 6, or a current depending on the requirements of the load unit 606.

The logic circuit 608 in the power control circuit 602 may receive a control input from a host device (not shown), for example a processor, indicating the power requirements of the load unit 606. For example, the control input may indicate that a 5-V voltage signal or 20-mA current or the like needs to be supplied to the load. The DAC 610 may convert the control input to an analog control signal, which may then be used to control the high voltage circuitry 612. The high voltage circuitry 612 may receive the power supply V1-V2 as input, and may convert the power supply V1-V2 to the load signal V3 based on the analog control signal. For example, the high voltage circuitry 612 may include circuitry, such as a voltage amplifier, to scale and/or buffer the analog control signal to generate a load signal V3, which is supplied by the power supply V1-V2. The load signal V3 may be lower in magnitude than the magnitude of power supply V1-V2. The load signal V3 may fluctuate over time. In this embodiment of FIG. 6, the load signal is shown as, but is not limited to, voltage V3; the load signal may also be a current. For example, the high voltage circuitry 612 may also include a voltage-to-current circuitry, driven by the analog control signal and powered by the power supply V1-V2, to generate a current to be provided to load unit 606.

The feedback control unit 614 may be coupled to the output of the high voltage circuitry 612 and may sense the load signal V3. For example, the feedback control unit 614 may sense the magnitude of the load signal V3. Alternatively, in applications where there may be any variation in the remote ground where the load is located, the feedback control unit 114 may sense the difference between the load signal V3 and the remote ground. The feedback control unit 614 may also sense the power supply V1-V2. For example, the feedback control unit 614 may sense the magnitude of the power supply V1-V2. The feedback control unit 614 may compare the magnitudes of the power supply V1-V2 and the load signal V3. Based on the comparison, the feedback control unit 614 may generate a feedback signal to transmit to the power management block 604. The feedback signal may provide instructions for the power management block 604 to dynamically adjust at least one of the voltages V1 and V2 to track the fluctuations in the load signal V3.

For example, the feedback control unit 614 may send the feedback signal to the feedback node of the DC-DC controller 616, wherein isolation is provided by the isolation block 626. Although not shown in FIG. 6, the feedback signal, which is a digital signal, may be converted to an analog signal before being sent to the feedback node of the DC-DC controller 616. It may also be possible to send the feedback signal as a digital signal to the feedback node of the DC-DC controller 616. The feedback node of the DC-DC controller 616 may act as a voltage control input. Therefore, the DC-DC controller 616 may dynamically adjust at least one of the voltages V1 and V2 to track the load signal V3 based on the feedback signal.

Several embodiments of the invention are specifically illustrated and/or described herein. However, it will be appreciated that modifications and variations of the invention are covered by the above teachings and within the purview of the appended claims without departing from the spirit and intended scope of the invention.

### EXAMPLES AND NOTES

In Example 1, an integrated circuit can include a processing system to generate a load signal from a variable power supply external to the integrated circuit, and a feedback circuit to compare the load signal and a voltage input from the variable power supply, and based on the comparison, to generate a feedback signal for adjusting the variable power supply.

In Example 2, the processing system of Example 1 optionally includes a logic circuit to receive a control input relating to a desired load signal value and to generate a control signal based on the control input, a digital-to-analog converter to convert the control signal to an analog control signal, and processing circuitry to receive the analog control signal and the power supply, and to generate the load signal.

In Example 3, the load signal of any one or more of Examples 1-2 optionally is a voltage.

In Example 4, the load signal of any one or more of Examples 1-3 optionally is a current.

In Example 5, the circuit of any one or more of Examples 1-4 optionally includes an input to receive the voltage input as a rail-to-rail voltage.

In Example 6, the variable power supply of any one or more of Examples 1-5 optionally includes a divider network, and the feedback circuit is configured to be coupled to a connection point of the divider network.

In Example 7, the divider network of any one or more of Examples 1-6 optionally includes two or more impedance elements.

In Example 8, the variable power supply of any one or more of Examples 1-7 optionally includes a DC-DC controller, and the feedback circuit is configured to be coupled directly to the DC-DC controller.

In Example 9, the feedback signal of any one or more of Examples 1-8 optionally is a digital signal.

In Example 10, the feedback signal of any one or more of Examples 1-9 optionally is converted into an analog signal prior to being transmitted to the variable power supply.

In Example 11, the variable power supply of any one or more of Examples 1-10 optionally is isolated from the processing system via a plurality of isolation units.

In Example 12, a method can include receiving a variable power supply from an external source, converting the variable power supply to a load signal, which is lower in magnitude than the power supply, sensing a value of the load signal, comparing the value of the load signal and a value of the power supply, generating, based on the comparison, a feedback signal to modify the variable power supply, and transmitting the feedback signal to the external source.

In Example 13, the converting the variable power supply to the load signal of any one or more of Examples 1-12 optionally includes receiving a control input relating to a desired value for the load signal, generating a control signal based on the control input, converting the control signal to an analog control signal, and generating the load signal from the variable power supply based on the analog control signal.

In Example 14, the method of any one or more of Examples 1-13 optionally includes converting the feedback signal from a digital signal to an analog signal before transmitting the feedback signal to the external source.

In Example 15, a system can include a power management unit to generate an input power signal, a load unit for receiving a load supply signal that is different from the input power signal, and a power supply unit, coupled to the power management unit and the load unit. The power supply unit can include an input to receive the input power signal, circuitry to generate the load supply signal from the input power signal, and a feedback circuit to generate a feedback signal based on variation in a difference between the load supply signal and the input power signal, wherein the power management unit receives the feedback signal and adjusts the input power signal based on the feedback signal.

In Example 16, the circuitry of any one or more of Examples 1-15 optionally includes a logic block to receive an external control input relating to a desired load supply signal and to generate a control signal based on the external control input, a converter to generate an analog control signal from the control signal, and a power conversion circuitry to receive the analog control signal and the input power signal, and to generate the load supply signal.

In Example 17, the load supply signal of any one or more of Examples 1-16 optionally is a voltage.

In Example 18, the load supply signal of any one or more of Examples 1-17 optionally is a current.

In Example 19, the power management unit of any one or more of Examples 1-18 optionally is isolated from the power supply via a plurality of isolation units.

In Example 20, the feedback signal of any one or more of Examples 1-19 optionally is converted from a digital signal to an analog signal before being received by the power management unit.

In Example 21, the power management unit of any one or more of Examples 1-20 optionally comprises a DC-DC controller.

In Example 22, the DC-DC controller of any one or more of Examples 1-21 optionally receives the feedback signal directly.

In Example 23, the DC-DC controller of any one or more of Examples 1-22 optionally is coupled to a divider network, which receives the feedback signal.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

We claim:

1. An integrated circuit, comprising:
a processing system to generate a load signal from a variable power supply external to the integrated circuit; and
a feedback circuit to compare the load signal and a voltage input from the variable power supply, and based on the comparison, to generate a feedback signal for adjusting the variable power supply.

2. The circuit of claim 1, wherein the processing system comprises:
a logic circuit to receive a control input relating to a desired load signal value and to generate a control signal based on the control input;
a digital-to-analog converter to convert the control signal to an analog control signal; and
processing circuitry to receive the analog control signal and the power supply, and to generate the load signal.

3. The circuit of claim 1, wherein the load signal is a voltage.

4. The circuit of claim 1, wherein the load signal is a current.

5. The circuit of claim 1, further comprising an input to receive the voltage input as a rail-to-rail voltage.

6. The circuit of claim 1, wherein the variable power supply includes a divider network, and the feedback circuit is configured to be coupled to a connection point of the divider network.

7. The circuit of claim 6, wherein the divider network includes two or more impedance elements.

8. The circuit of claim 1, wherein the variable power supply includes a DC-DC controller, and the feedback circuit is configured to be coupled directly to the DC-DC controller.

9. The circuit of claim 1, wherein the feedback signal is a digital signal.

10. The circuit of claim 9, wherein the feedback signal is converted into an analog signal prior to being transmitted to the variable power supply.

11. The circuit of claim 1, wherein the variable power supply is isolated from the processing system via a plurality of isolation units.

12. A method, comprising:
receiving a variable power supply from an external source;
converting the variable power supply to a load signal, which is lower in magnitude than the power supply;
sensing a value of the load signal;
comparing the value of the load signal and a value of the power supply;
generating, based on the comparison, a feedback signal to modify the variable power supply; and
transmitting the feedback signal to the external source.

13. The method of claim 12, wherein converting the variable power supply to the load signal comprises:
receiving a control input relating to a desired value for the load signal;
generating a control signal based on the control input;
converting the control signal to an analog control signal; and
generating the load signal from the variable power supply based on the analog control signal.

14. The method of claim 12, further comprising:
converting the feedback signal from a digital signal to an analog signal before transmitting the feedback signal to the external source.

15. A system, comprising:
a power management unit to generate an input power signal;
a load unit for receiving a load supply signal that is different from the input power signal; and
a power supply unit, coupled to the power management unit and the load unit, comprising:
an input to receive the input power signal,
circuitry to generate the load supply signal from the input power signal, and
a feedback circuit to generate a feedback signal based on variation in a difference between the load supply signal and the input power signal,
wherein the power management unit receives the feedback signal and adjusts the input power signal based on the feedback signal.

16. The system of claim 15, wherein the circuitry comprises:
a logic block to receive an external control input relating to a desired load supply signal and to generate a control signal based on the external control input;
a converter to generate an analog control signal from the control signal; and
a power conversion circuitry to receive the analog control signal and the input power signal, and to generate the load supply signal.

17. The system of claim 15, wherein the power management unit is isolated from the power supply via a plurality of isolation units.

18. The system of claim 15, wherein the feedback signal is converted from a digital signal to an analog signal before being received by the power management unit.

19. The system of claim 15, wherein the power management unit comprises a DC-DC controller.
